(19) United States
(12) Patent Application Publication
(10) Pub. No.: US 2023/0162090 A1
(43) Pub. Date: May 25, 2023

(54) OBJECT-BASED DATA SCIENCE PLATFORM

(71) Applicant: Liveline Technologies Inc., Livonia, MI (US)

(72) Inventors: Christopher Edward Couch, Ann Arbor, MI (US); Yang He, Toronto (CA); Joseph Hernandez, Farmington Hills, MI (US)

(21) Appl. No.: 18/056,391

(22) Filed: Nov. 17, 2022

Related U.S. Application Data
(60) Provisional application No. 63/281,433, filed on Nov. 19, 2021.

(51) Int. Cl. G06N 20/00; G06N 3/08

(52) U.S. Cl. CPC G06N 20/00; G06N 3/08

(57) ABSTRACT

A plurality of data package objects each contains signal data describing time-series values for parameters, organizes the signal data into batches having a size less than a memory, identifies the batches according to indices, and responsive to requests, provides output identifying the indices in randomly shuffled or arbitrary order, loads into the memory one of the batches such that features of the signal data of the one of the batches can be used to train a machine learning model to predict time-series parameter outputs from time-series parameter inputs, and removes from the memory the one of the batches to prevent the one of the batches and other of the batches from completely occupying all of the memory at a same time.

### CROSS-REFERENCE TO RELATED APPLICATIONS

This application claims the benefit of Provisional App. No. 63/281,433, filed Nov. 19, 2021, which is hereby incorporated by reference in its entirety.

### TECHNICAL FIELD

This disclosure relates to the training of artificial intelligence and memory management associated therewith.

### BACKGROUND

“Intelligence” demonstrated by machines can take the form of agents that make predictions from a stream of data values describing various phenomena. Intelligent models can, for example, attempt to predict future stock prices or outputs from a manufacturing operation given various data. Such models are often trained on large amounts of data.

### SUMMARY

A computer system includes a memory and a processor. The processor is programmed to construct and utilize a plurality of data package objects. Each of the data package objects contains signal data describing time-series values for parameters, organizes the signal data into batches having a size less than the memory, and identifies the batches according to indices. Each of the data package objects further, responsive to requests, provides output identifying the indices in randomly shuffled or arbitrary order, loads into the memory one of the batches such that features of the signal data of the one of the batches can be used to train a machine learning model to predict time-series parameter outputs from time-series parameter inputs, and removes from the memory the one of the batches to prevent the one of the batches and other of the batches from completely occupying all of the memory at a same time.

An embedded system includes a hardware registry and a microcontroller. The microcontroller is programmed to construct and utilize a plurality of data package objects. Each of the data package objects contains signal data describing time-series values for parameters, organizes the signal data into batches having a size less than the hardware registry, and identifies the batches according to indices. Each of the data package objects further, responsive to requests, provides output identifying the indices in randomly shuffled or arbitrary order, loads into the hardware registry one of the batches such that features of the signal data of the one of the batches can be used to train a machine learning model to predict time-series parameter outputs from time-series parameter inputs, and removes from the hardware registry the one of the batches to prevent the one of the batches and other of the batches from completely occupying all of the hardware registry at a same time.

### BRIEF DESCRIPTION OF THE DRAWINGS

FIG. 1 is schematic diagram of relationships between various objects of an object-based data science platform.

### DETAILED DESCRIPTION

Embodiments are described herein. It is to be understood, however, that the disclosed embodiments are merely examples and other embodiments may take various and alternative forms. The figure is not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated or described with reference to any one example may be combined with features illustrated or described in one or more other examples to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Training of artificial intelligence, such as machine learning models (e.g., sequence to sequency models, etc.) is often done in a bespoke fashion. Data scientists, for example, create custom code for loading and pre-processing data to be used in training machine learning models. Introduction of different models or different data, however, can result in the need for additional custom code. Moreover, the amount of data used to train an artificial intelligence can exceed available memory. Here, we introduce a platform that has reusable objects to reduce the need for custom code and large amounts of memory when training artificial intelligence.

Several types of objects are contemplated, including a project object, an experiment package object, a data package object, a pipeline object, a model package object, and others. When instantiated from their corresponding class, they inherit the respective functionality described below. All may be distinct and serializable, and can be saved as files and managed as versions. And these objects, when executed by a processor or microcontroller for example, cooperate to facilitate model training.

In one example, a state-based interface (“seq2seq”) to a software physics package (“physics”) and with multiple functions is contemplated. These functions constitute a high-level project application programming interface (API) for setting up and running what will be referred to as a project. Use of the project API is generally preferred over an object API when possible.

Project API Example # Import state-based interface; Project API is now available

From physics import seq2seq as pjt

# Extract data from a source

pjt.extract_data(source=‘manufacturing plant’, run_id=140, search=‘files’)

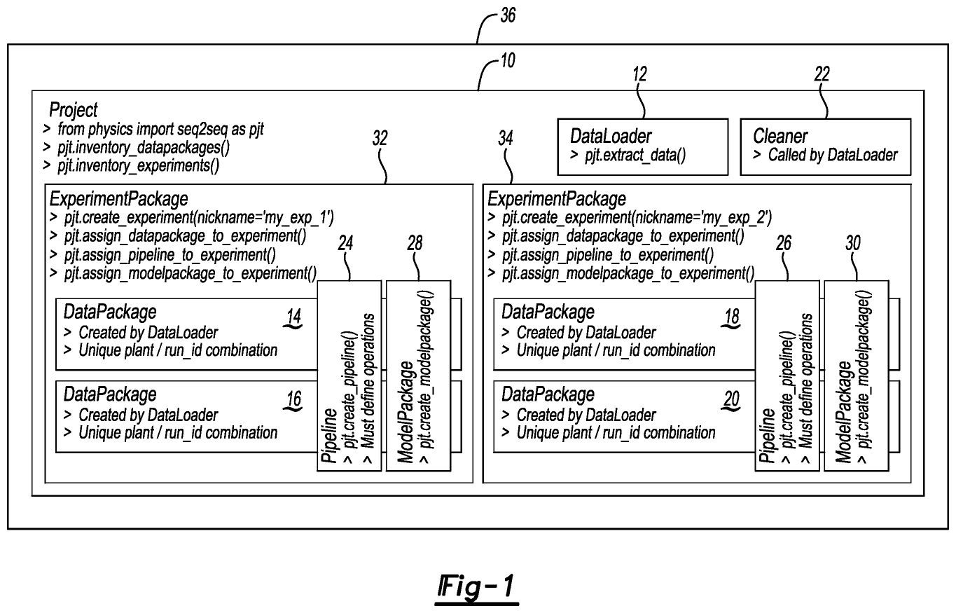

Conceptually, the state-based interface maintains relationships between its major object classes as illustrated in FIG. 1. Some project-level functions are shown. The state-based interface thus can be understood to be a collection of convenient functions that call various object APIs. This approach allows the handling of project objects as distinct “packages” that can be saved, reused, and re-combined in useful ways. For example, a trained model in an experiment can be validated against new data simply by switching out the data package object and calling the experiment's validation method again. Likewise, a feature engineering pipeline that works well with data from equipment producing a certain product can be saved and applied to data from other equipment producing the same product.

The following briefly introduces various objects with reference to FIG. 1. A project object 10 can manage stateful registries of various other objects 12-34 and defines a high-level project API. The data loader object 12 obtains data from a cloud, database, or other file sources, puts the data into the data package objects 14, 16, 18, 20, and registers to the project object 10. The cleaner object 22 performs pre-processing for the data package objects 14, 16, 18, 20 (e.g., examines integrity of data and attempts to fix or exclude problematic portions of same) and provides machine learning functionality for selecting signals and creating features from the data. The data package objects 14, 16, 18, 20 provide custom containers for the data and corresponding metadata, visualization tools, resampling utilities, etc. The pipeline objects 24, 26 transform the data in the data package objects 14, 16, 18, 20 and create new features. Processing steps are defined by adding pipeline operation objects. The model packages 28, 30 define a model architecture for training and has utilities for binarizing and exporting models. The experiment package objects 32, 34 define a trainable setup after required objects, such as data package objects, pipeline objects, and model package objects, are assigned. The objects assigned to a given experiment package object, such as the data package objects 14, 16, can be re-used across various experiment package objects. They also can be saved for re-use in other experiment package objects, as can an entire project object. As briefly mentioned earlier, a processor and memory 36 (or alternatively a microcontroller and hardware registry of an embedded system) can be programmed to execute the objects 10-34 and store the corresponding data and metadata therein.

In addition to the project API, various objects can be exposed directly utilizing their individual object API. This, however, may not be generally useful in a production environment. It may, however, be convenient to use object APIs for certain tasks, such as visualizing raw data in a data package object, or running speed benchmark tests on signal processing operations contained in a pipeline object.

```
Object API Example
  from physics import seq2seq as pjt
  # Extract data using Project API
  pjt.extract_data(source=‘manufacturing plant’, run_id=140, search=‘files’)
  # Expose the DataPackage just created and visualize raw data with Object API
  dpk = pjt.get_datapackage( )
  dpk.plot_data( )
  # Create a feature transformation Pipeline using Project API
  pjt.create_pipeline( )
  # Expose the Pipeline just created and add an operation with Object API
  p = pjt.get_pipeline( )
  p.add_operation(
    transformation_obj=‘StandardScaler’,
    )
  # Onboard (bring into memory) DataPackage contents
  dpk.onboard( )
  # Fit Pipeline operations to data, and benchmark execution speed
  p.fit_to_dataframe(df = dpk.source.data)
  p.benchmark(df=dpk.source.data)
```

More generally, a data package object can contain raw signal data (e.g., time-series values for parameters, such as temperature sensor and motor amperage, of manufacturing equipment during operation, etc.) and corresponding metadata (e.g., data describing control limits, such as the operating temperature range and power limits, for the manufacturing equipment, etc.). A data package object can also have several management features related to the data it contains. These features include knowing the size of the data; constructing and indexing batches (e.g., subsets) from the data, with each batch typically having a size less than the size of available memory; shuffling of the batch indices; loading a requested batch into memory; and removing the batch from memory.

A pipeline object can contain a predefined and configurable sequence of data processing operations (e.g., frequency analysis, statistical analysis, etc.) that create features of interest from the data, and can operate across an arbitrarily large number of data package objects. The operations, for example, can define which signals are targeted by each operation, and can be saved as a single object that can be called and used again. As a result, a sequence of steps for preparing data from a certain type of source (e.g., a factory) can be saved, and every time data from that source is used to update training of a corresponding model, the same sequence of steps for preparing the data can be called by loading the corresponding pipeline object. An example sequence of operations defined by a pipeline object may include generating a moving average on temperature data, scaling data so everything is zero mean, performing frequency analysis on pressure signals to create wavelets, etc.

A model package can contain machine learning models (e.g., a sequence to sequence model, etc.) and a taxonomy of all parameters required to reconstruct the machine learning models after training (e.g., sequence lengths, number of neural network layers, number of inputs and outputs, trained weights of neural network elements, etc.), and have the ability to serialize, save, and reload them. Once loaded, the model is reconstituted into memory and can be used or trained.

An experiment package object can provide functional tools to use the various sub-packages together. It is serializable and contains all data needed to reconstruct in different run times, and will thus run training, validation, and simulation, and can make plots of model performance: It is the orchestrator for model training.

The memory management features associated with the data package objects allow the platform to use an arbitrarily large number of data package objects for a particular model even if all of those data sources could not simultaneously fit in memory. As mentioned above, the data package object has knowledge of important features of the data including its size and how many batches (e.g., subsets) can be constructed from the data, and can index such batches. A corresponding experiment package can look at its data packages even though the data is not yet in memory, and generate requests for the data packages to randomly shuffle and report their indices of available batches. Across all of the data packages, the experiment package can thus select batches at random. The data package holding the selected batch will load the batch's data and corresponding metadata into memory for use by the experiment package for training of the model to, for example, predict time-series parameter outputs of manufacturing equipment from time-series parameter inputs to the manufacturing equipment subject to control limits defined by the metadata, and then remove the data from memory when training of the model on the data is finished so that the memory is not overwhelmed with data from the various batches. As such, the experiment package can iterate through all batches of the data packages randomly for multiple epochs of model training, which is advantageous for efficiently training machine learning models.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. For example, the words processor and processors may be used interchangeably, and the words microcontroller and microcontrollers may be used interchangeably.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A computer system comprising:
a memory; and
a processor programmed to construct and utilize a plurality of data package objects that each
contains signal data describing time-series values for parameters,
organizes the signal data into batches having a size less than the memory,
identifies the batches according to indices, and
responsive to requests, provides output identifying the indices in randomly shuffled or arbitrary order, loads into the memory one of the batches such that features of the signal data of the one of the batches can be used to train a machine learning model to predict time-series parameter outputs from time-series parameter inputs, and removes from the memory the one of the batches to prevent the one of the batches and other of the batches from completely occupying all of the memory at a same time.

2. The computer system of claim 1, wherein the signal data describes time-series values for parameters of manufacturing equipment.

3. The computer system of claim 1, wherein the machine learning model is a sequence to sequence model.

4. The computer system of claim 1, wherein the processor is further programmed to construct and utilize an experiment package object that, based on the output identifying the indices from the data package objects, generates the requests such that the batches that are sequentially loaded into and removed from the memory are from different ones of the data package objects.

5. The computer system of claim 1, wherein each of the data package objects further contains metadata describing control limits.

6. The computer system of claim 5, wherein each of the data package objects, responsive to the requests, further loads into the memory the metadata such that the machine learning model is trained subject to the control limits.

7. The computer system of claim 1, wherein the processor is further programmed to construct and utilize an experiment package object that generates the requests such that all of the batches from all of the data package objects are loaded into and removed from the memory in random order for multiple epochs of model training.

8. The computer system of claim 1, wherein the processor is further programmed to construct and utilize a pipeline object that performs a predefined and configurable sequence of data processing operations on the signal data to generate the features for modeling.

9. The computer system of claim 1, wherein the processor is further programmed to construct and utilize a model package object that contains the machine learning model and a taxonomy of all parameters required to reconstruct the machine learning model after training.

10. The computer system of claim 1, wherein the processor is further programmed to save the data package objects, experiment package objects, pipeline objects, or model package objects as serialized file objects that can be stored and loaded into the memory for re-use.

11. An embedded system comprising:
a hardware registry; and
a microcontroller programmed to construct and utilize a plurality of data package objects that each
contains signal data describing time-series values for parameters,
organizes the signal data into batches having a size less than the hardware registry,
identifies the batches according to indices, and
responsive to requests, provides output identifying the indices in randomly shuffled or arbitrary order, loads into the hardware registry one of the batches such that features of the signal data of the one of the batches can be used to train a machine learning model to predict time-series parameter outputs from time-series parameter inputs, and removes from the hardware registry the one of the batches to prevent the one of the batches and other of the batches from completely occupying all of the hardware registry at a same time.

12. The embedded system of claim 11, wherein the signal data describes time-series values for parameters of manufacturing equipment.

13. The embedded system of claim 11, wherein the machine learning model is a sequence to sequence model.

14. The embedded system of claim 11, wherein the microcontroller is further programmed to construct and utilize an experiment package object that, based on the output identifying the indices from the data package objects, generates the requests such that the batches that are sequentially loaded into and removed from the hardware registry are from different ones of the data package objects.

15. The embedded system of claim 11, wherein each of the data package objects further contains metadata describing control limits.

16. The embedded system of claim 15, wherein each of the data package objects, responsive to the requests, further loads into the hardware registry the metadata such that the machine learning model is trained subject to the control limits.

17. The embedded system of claim 11, wherein the microcontroller is further programmed to construct and utilize an experiment package object that generates the requests such that all of the batches from all of the data package objects are loaded into and removed from the hardware registry in random order for multiple epochs of model training.

18. The embedded system of claim 11, wherein the microcontroller is further programmed to construct and utilize a pipeline object that performs a predefined and configurable sequence of data processing operations on the signal data to generate the features for modeling.

19. The embedded system of claim 11, wherein the microcontroller is further programmed to construct and utilize a model package object that contains the machine learning model and a taxonomy of all parameters required to reconstruct the machine learning model after training.

20. The embedded system of claim 11, wherein the microcontroller is further programmed to save the data package objects, experiment package objects, pipeline objects, or model package objects as serialized file objects that can be stored and loaded into the hardware registry for re-use.
